(19) United States
(12) Patent Application Publication
(10) Pub. No.: US 2026/0251471 A1
(43) Pub. Date: Aug. 27, 2026

(54) SYSTEM

(71) Applicant: SoftBank Group Corp., Tokyo (JP)

(72) Inventor: Kouji SAIKA, Tokyo (JP)

(73) Assignee: SoftBank Group Corp., Tokyo (JP)

(21) Appl. No.: 19/537,640

(22) Filed: Feb. 12, 2026

(30) Foreign Application Priority Data
Feb. 21, 2025 (JP) 2025-027039

(51) Int. Cl. G01C 21/36; G06F 3/01; H04L 51/02

(52) U.S. Cl. CPC G01C 21/3685; G06F 3/011; H04L 51/02; G06F 2203/011

(57) ABSTRACT

The system according to the embodiment comprises an issuing unit, a confirmation unit, and an allocation unit. The issuing unit is configured to immediately issue a number of an available parking space within the parking lot. The confirmation unit is configured to confirm the number issued by the issuing unit. The allocation unit is configured to allocate the number of the parking space according to the vehicle type and the age or skill of the driver.

### CROSS-REFERENCE TO RELATED APPLICATION

The present application claims priority to and incorporates by reference the entire contents of Japanese Patent Application No. 2025-027039 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem in that it takes time and effort to search for an available parking space within a parking lot, making efficient parking difficult.

### SUMMARY OF THE INVENTION

The system according to the embodiment comprises an issuing unit, a confirmation unit, and an allocation unit. The issuing unit is configured to immediately issue a number of an available parking space within the parking lot. The confirmation unit is configured to confirm the number issued by the issuing unit. The allocation unit is configured to allocate the number of the parking space according to the vehicle type and the age or skill of the driver.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

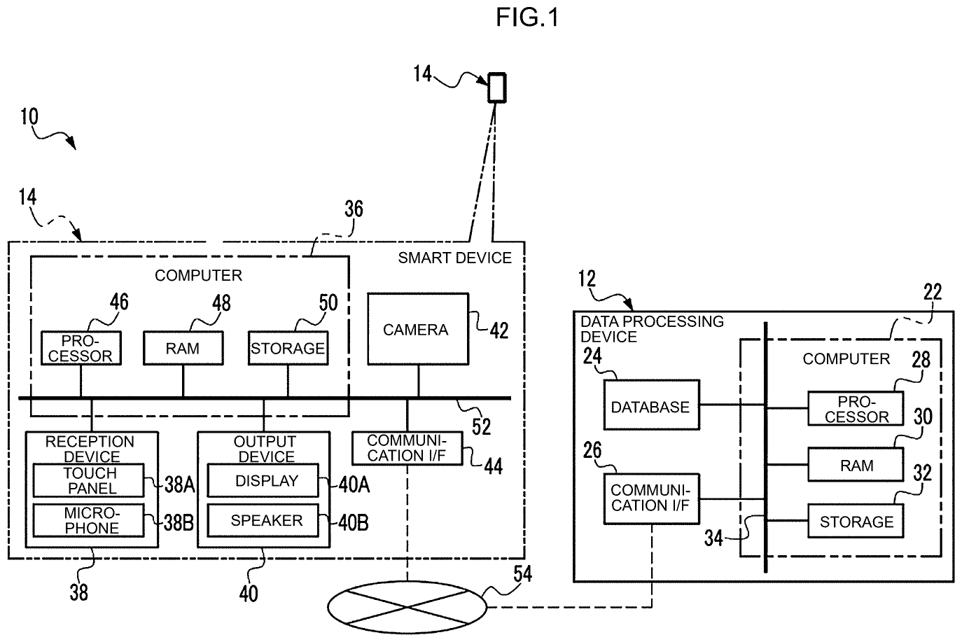

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

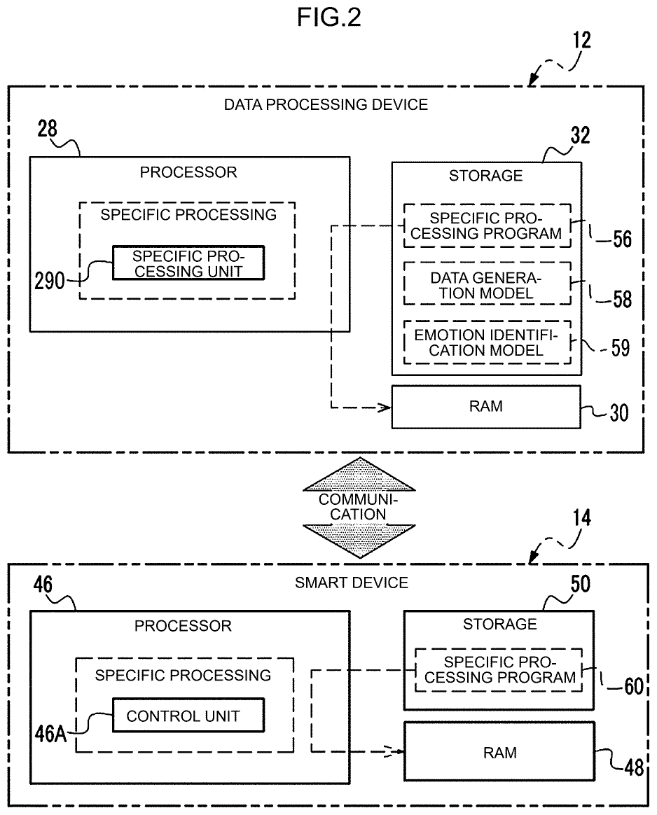

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The parking space guidance system according to the embodiment of the present invention is a system designed to eliminate the need to search for available parking spaces within a parking lot. This parking space guidance system immediately issues the number of an available parking space upon entry into the parking lot. The number can be confirmed via a ticket, a smartphone application, or a monitor of the vehicle. As a result, the driver can proceed directly to the designated parking space without wandering around the parking lot unnecessarily. Furthermore, this system has a function to allocate the number of the parking space according to the vehicle type and the age or skill of the driver. For example, large vehicles or drivers who are inexperienced in driving can be assigned a wide parking space or a location with easy access. This reduces the difficulty of parking and lowers the risk of contact accidents. For instance, the parking space guidance system issues the number of an available parking space immediately upon entry into the parking lot, and the number can be confirmed via a ticket, a smartphone application, or a monitor of the vehicle. This allows the driver to go directly to the designated parking space without unnecessary searching. Additionally, the system allocates the number of the parking space according to the vehicle type and the age or skill of the driver. For example, large vehicles or drivers who are inexperienced in driving can be assigned a wide parking space or a location with easy access, thereby reducing parking difficulty and the risk of contact accidents. The advantages of this system for drivers include time savings, stress reduction, and a decrease in contact accidents. For parking lot operators, benefits include reduced labor costs for attendants and improved turnover rates of the parking lot. Thus, the parking space guidance system can eliminate the need to search for available parking spaces within the parking lot. Specifically, the parking space guidance system installs multiple sensor networks and camera image analysis devices within the parking lot to detect the occupancy status of each parking space in real time. The system aggregates sensor data (e.g., binary occupancy flags for each parking space, object detection results extracted from camera images, time information, etc.) to generate a list of available parking spaces. The issuing unit receives input parameters such as vehicle ID at the entry gate and driver attributes (vehicle type, age, driving history, past usage history, etc.) based on the list of available parking spaces, and determines the optimal parking space number. For example, input data may include attribute vectors such as “vehicle type: SUV,” “driver age: 65,” “past parking history: prefers locations near the entrance.” The issuing unit combines these attribute vectors with the physical characteristics of available parking spaces (width, presence of obstacles, distance from entrance/exit, congestion score, etc.) and selects the optimal parking space using rule-based or machine learning models (e.g., decision trees, random forests, neural networks, etc.). When using an AI model, the input consists of attribute vectors plus a parking lot status tensor (e.g., an N-space×M-feature matrix), and the output is a “recommended parking space number” or a “list of multiple candidates with recommendation scores.” For example, output examples include “Parking space No. 12 (recommendation score 0.92),” “Parking space No. 35 (recommendation score 0.85),” etc. The issuing unit immediately issues the parking space number with the highest recommendation score and notifies the confirmation unit. The confirmation unit displays the issued number via multiple interfaces such as paper tickets, smartphone applications, and in-vehicle displays. Furthermore, the allocation unit dynamically adjusts the allocation criteria for parking spaces according to vehicle type and driver attributes based on AI inference results or rule-based judgments. For example, for drivers who are inexperienced in driving, higher weights are set for “distance from entrance/exit,” “presence of adjacent vehicles,” and “parking space width,” and allocation is performed using optimization algorithms. Unlike conventional manual guidance or simple allocation of available spaces, this enables optimization that simultaneously considers multiple high-dimensional features, resulting in technical effects such as improved turnover rates for the entire parking lot, reduced accident risk, and enhanced user experience. Applicable fields include parking lots for large commercial facilities, airports, stations, temporary parking lots for event venues, and dedicated parking lots for hospitals and elderly care facilities, covering a wide range of parking lots with diverse user attributes and vehicle types.

The parking space guidance system according to the embodiment comprises an issuing unit, a confirmation unit, and an allocation unit. The issuing unit immediately issues the number of an available parking space within the parking lot. For example, the issuing unit issues the number of an available parking space immediately upon entry into the parking lot. The issuing unit can issue the number of an available parking space within a few seconds. The confirmation unit confirms the number issued by the issuing unit. For example, the confirmation unit confirms the number via a ticket, a smartphone application, or a monitor of the vehicle. The confirmation unit can confirm the number using, for example, a paper ticket, an electronic ticket, a dedicated application, a general navigation application, a dashboard monitor, or a head-up display. The allocation unit allocates the number of the parking space according to the vehicle type and the age or skill of the driver. For example, the allocation unit assigns a wide parking space or a location with easy access to large vehicles or drivers who are inexperienced in driving. The allocation unit can assign a parking space that is twice as wide as a standard parking space. Additionally, the allocation unit can assign a location with easy access by considering the position of the parking space and the presence of obstacles in the surroundings. Thus, the parking space guidance system according to the embodiment can immediately issue, confirm, and allocate the number of an available parking space within the parking lot. Specifically, the parking space guidance system installs multiple sensor networks (e.g., ultrasonic sensors, magnetic sensors, image recognition cameras, etc.) in each parking space within the parking lot and transmits data from each sensor to an aggregation server in real time. The issuing unit receives these sensor data (e.g., binary occupancy flags for each parking space, object detection results extracted from camera images, time information, etc.) and generates a list of available parking spaces. The issuing unit receives vehicle ID (e.g., license plate recognition results or IC card ID) and driver attributes (e.g., vehicle type, age, driving history, past usage history, etc.) as input parameters upon passing through the entry gate, and determines the optimal parking space number by combining these with the list of available parking spaces. For example, input data may include attribute vectors such as “vehicle type: SUV,” “driver age: 65,” “past parking history: prefers locations near the entrance.” The issuing unit combines these attribute vectors with the physical characteristics of available parking spaces (width, presence of obstacles, distance from entrance/exit, congestion score, etc.) and selects the optimal parking space using rule-based or machine learning models (e.g., decision trees, random forests, neural networks, etc.). When using an AI model, the input consists of attribute vectors plus a parking lot status tensor (e.g., an N-space×M-feature matrix), and the output is a “recommended parking space number” or a “list of multiple candidates with recommendation scores.” For example, output examples include “Parking space No. 12 (recommendation score 0.92),” “Parking space No. 35 (recommendation score 0.85),” etc. The issuing unit immediately issues the parking space number with the highest recommendation score and notifies the confirmation unit. The confirmation unit displays the issued number via multiple interfaces such as paper tickets, smartphone applications, and in-vehicle displays. Furthermore, the allocation unit dynamically adjusts the allocation criteria for parking spaces according to vehicle type and driver attributes based on AI inference results or rule-based judgments. For example, for drivers who are inexperienced in driving, higher weights are set for “distance from entrance/exit,” “presence of adjacent vehicles,” and “parking space width,” and allocation is performed using optimization algorithms. Unlike conventional manual guidance or simple allocation of available spaces, this enables optimization that simultaneously considers multiple high-dimensional features, resulting in technical effects such as improved turnover rates for the entire parking lot, reduced accident risk, and enhanced user experience. Applicable fields include parking lots for large commercial facilities, airports, stations, temporary parking lots for event venues, and dedicated parking lots for hospitals and elderly care facilities, covering a wide range of parking lots with diverse user attributes and vehicle types.

The confirmation unit can confirm the number via a ticket, a smartphone application, or a monitor of the vehicle. The confirmation unit can confirm the number using, for example, a paper ticket, an electronic ticket, a dedicated application, a general navigation application, a dashboard monitor, or a head-up display. For example, the confirmation unit issues a paper ticket that the driver can check. The confirmation unit can also display the number using a smartphone application, allowing the driver to confirm it on their smartphone. Furthermore, the confirmation unit can display the number on the vehicle's monitor, enabling the driver to confirm it inside the vehicle. As a result, the means for confirming the number are diverse, improving user convenience. Specifically, the confirmation unit has a function to immediately distribute parking space number data received from the issuing unit (e.g., integer-type ID, list with recommendation scores, timestamp, etc.) to multiple output interfaces. In the case of a paper ticket issuing device, the confirmation unit prints the number, QR code, and parking space location map via a thermal printer control module, allowing the user to physically confirm them. In the case of a smartphone application, the confirmation unit pushes the number data to the user's device using Bluetooth Low Energy or Wi-Fi communication, and can provide map-linked display and voice guidance within the application. In the case of an in-vehicle display, the confirmation unit sends the number data to the vehicle infotainment system via CAN communication or in-vehicle Ethernet, displaying it on the dashboard or head-up display with a highly visible UI. Furthermore, the confirmation unit can dynamically switch the display layout and notification method according to user attributes and usage history. For example, for elderly users, large fonts and voice readout are used together, while for business users, the shortest route and congestion status are displayed simultaneously, enabling individual optimization. When incorporating an AI model, the confirmation unit uses the user's past operation history and real-time emotion estimation results (e.g., facial expression recognition scores from face images, stress estimation values from voice input, etc.) as input to infer the optimal display method and notification timing. For example, input examples include “user attribute vector (age: 65, weak eyesight, device: smartphone),” “emotion score: high stress,” and output examples include “voice notification ON+large font display,” “simple display of key points only,” etc. Thus, the confirmation unit can provide a variety of interfaces optimized for each user, greatly improving visibility, operability, and accessibility compared to conventional single display methods. Applicable fields include general parking lots as well as parking lot systems for airports, hospitals, elderly care facilities, and event venues, which have diverse user groups and usage scenarios.

The allocation unit can assign a wide parking space or a location with easy access to large vehicles or drivers who are inexperienced in driving. For example, the allocation unit can assign a parking space that is twice as wide as a standard parking space. Additionally, the allocation unit can assign a location with easy access by considering the position of the parking space and the presence of obstacles in the surroundings. For example, the allocation unit can assign a wide parking space to large vehicles. The allocation unit can also assign a location with easy access to drivers who are inexperienced in driving. By assigning parking spaces suitable for large vehicles or drivers who are inexperienced in driving, the difficulty of parking is reduced and the risk of contact accidents is lowered. Specifically, the allocation unit receives vehicle attribute data (e.g., vehicle size, width, length, height, vehicle category, etc.) and driver attribute data (e.g., age, driving history, past accident history, usage frequency, etc.) obtained at the entry gate as input parameters. The allocation unit combines these attribute vectors with the physical feature quantities of each parking space in the parking lot (e.g., space width, length, presence of adjacent vehicles, distance to obstacles, distance from entrance/exit, congestion score, etc.) to perform optimal allocation. Allocation algorithms may include rule-based methods (e.g., vehicles wider than 2 m are limited to spaces at least 2.5 m wide), decision trees, random forests, neural networks (e.g., multilayer perceptron, LightGBM, etc.), and others. When using an AI model, the input consists of “vehicle attributes+driver attributes+parking lot status tensor (N spaces×M features),” and the output is a “recommended parking space number” or a “list of candidates with recommendation scores.” For example, input examples include “vehicle type: large SUV,” “driving history: 1 year,” “past parking history: prefers locations near the entrance,” and output examples include “Parking space No. 5 (recommendation score 0.95, width 2.8 m, 10 m from entrance),” etc. The allocation unit immediately assigns the parking space with the highest recommendation score and notifies the issuing unit and confirmation unit. Furthermore, the allocation unit can dynamically adjust the weights of allocation criteria according to user attributes and parking lot congestion status (e.g., prioritizing “distance from entrance” for elderly users, “no adjacent vehicles” for beginners, etc.). In this way, the allocation unit automatically performs optimization that simultaneously considers multiple high-dimensional features, unlike human attendants' empirical rules or simple first-come-first-served allocation, resulting in significant improvements in allocation accuracy, safety, and user satisfaction. Applicable fields include parking lots for commercial facilities, airports, hospitals, elderly care facilities, and event venues, covering a wide range of parking lots with diverse vehicle types and user groups.

The issuing unit can immediately issue the number of an available parking space upon entry into the parking lot. The issuing unit can issue the number of an available parking space within a few seconds. For example, the issuing unit issues the number of an available parking space immediately upon entry into the parking lot. The issuing unit monitors the availability status within the parking lot in real time and can immediately issue the number of an available parking space. As a result, the driver can proceed directly to the designated parking space without wandering around the parking lot unnecessarily. Specifically, the issuing unit receives occupancy status data (e.g., binary occupancy flags, object detection labels, timestamps, etc.) from multiple sensor networks (e.g., ultrasonic sensors, magnetic sensors, image recognition cameras, etc.) installed in the parking lot, and transmits them to an aggregation server in real time. The issuing unit receives these sensor data and generates a parking lot status tensor (e.g., an N-space×M-feature matrix). The issuing unit applies a vacant space extraction algorithm (e.g., threshold judgment, object detection score filtering, etc.) to immediately generate a list of available parking spaces. When vehicle ID and driver attributes are received upon passing through the entry gate, the issuing unit combines this information with the list of available spaces to determine the optimal parking space number. When using an AI model, the input consists of “parking lot status tensor+vehicle attribute vector,” and the output is a “recommended parking space number” or a “list of candidates with recommendation scores.” For example, input examples include “parking lot status: available spaces No. 3, 7, 12,” “vehicle type: sedan,” and output examples include “Parking space No. 7 (recommendation score 0.93),” etc. The issuing unit immediately issues the parking space number with the highest recommendation score and notifies the confirmation unit. Furthermore, the issuing unit can dynamically optimize the parameters of the issuing algorithm according to issuing history and congestion status. Thus, the issuing unit realizes parking space issuing processing with excellent real-time performance, optimality, and scalability, unlike conventional manual guidance or simple allocation of available spaces, resulting in technical effects such as improved turnover rates for the entire parking lot, enhanced user experience, and alleviation of congestion. Applicable fields include parking lots for large commercial facilities, airports, event venues, hospitals, and other parking lots where real-time performance is required.

The issuing unit can estimate the emotion of the driver and adjust the number of the parking space to be issued based on the estimated emotion of the driver. For example, the issuing unit can estimate the emotion of the driver and adjust the number of the parking space to be issued based on the estimated emotion of the driver. For instance, if the driver is feeling stressed, the issuing unit issues a parking space near the entrance of the parking lot. If the driver is relaxed, the issuing unit can issue a quiet parking space in the back of the parking lot. Furthermore, if the driver is in a hurry, the issuing unit can issue a parking space with easy access. By adjusting the number of the parking space according to the emotion of the driver, the system can reduce the driver's stress and improve the convenience of parking. Emotion estimation is realized, for example, by using an emotion engine or generative AI for emotion estimation functions. Generative AI may include text generation AI (e.g., LLM) or multimodal generative AI, but is not limited to these examples. Some or all of the above-described processing in the issuing unit may be performed using AI or without using AI. For example, the issuing unit can input the driver's face image into generative AI to estimate emotion. Specifically, the issuing unit can input multiple modal data such as driver's face image data (e.g., RGB image, cropped face region, resolution 128×128 pixels, etc.), voice data (e.g., speech waveform, spectrogram, etc.), and text input (e.g., chat history, speech recognition results, etc.) into an AI model. The issuing unit uses a multimodal neural network (e.g., integrated CNN+RNN+Transformer) to integrate features extracted from each modality and outputs emotion classification (e.g., stress, relaxation, urgency, etc.) and emotion scores (e.g., stress level 0.85, etc.). For example, input examples include “face image: smiling,” “voice: high pitch, fast speech,” “text: in a hurry,” and output examples include “emotion label: stress,” “emotion score: 0.92,” etc. The issuing unit dynamically adjusts the weight parameters of the parking space allocation algorithm (e.g., “distance from entrance” emphasis, “quietness” emphasis, etc.) based on the estimated emotion label and score to determine the optimal parking space number. For example, if the stress level is high, “proximity to entrance” is emphasized; if relaxed, “quiet space in the back” is emphasized; if in a hurry, “entrance or along the aisle” is emphasized, and the allocation criteria are automatically switched. Furthermore, the issuing unit can continuously learn individual optimization by combining emotion estimation results with issuing history and user attributes. Thus, the issuing unit realizes highly accurate emotion estimation and dynamic allocation optimization by AI, unlike conventional uniform allocation or subjective human judgment, resulting in technical effects such as improved user experience, stress reduction, and safety. Applicable fields include general parking lots as well as parking lots for hospitals, elderly care facilities, airports, and event venues, where consideration of users' psychological states is required.

The issuing unit can analyze the congestion status of the parking lot in real time and issue an appropriate parking space number. For example, the issuing unit can monitor the congestion status of the parking lot in real time and immediately issue an available parking space. The issuing unit can also adjust the order of issuing parking spaces according to the congestion level of the parking lot. Furthermore, the issuing unit can analyze the congestion status of the parking lot and issue parking spaces to avoid congestion. For example, the issuing unit monitors the congestion status of the parking lot in real time and immediately issues available parking spaces. The issuing unit can adjust the order of issuing parking spaces according to the congestion level. The issuing unit can analyze the congestion status and issue parking spaces to avoid congestion. By analyzing the congestion status of the parking lot in real time, the system can issue optimal parking space numbers and promote efficient use of the parking lot. Specifically, the issuing unit aggregates real-time data (e.g., occupancy flags for each space, number of entries, number of exits, time information, etc.) collected from sensors within the parking lot (e.g., ultrasonic sensors, image recognition cameras, entry/exit gate counters, etc.) and calculates the overall congestion score of the parking lot (e.g., vacancy rate, area-specific congestion, peak prediction values, etc.). The issuing unit dynamically adjusts the order of issuing the list of available parking spaces and allocation criteria based on the congestion score. For example, when congestion is high, spaces near the entrance are prioritized to reduce travel distance and congestion risk within the lot. When congestion is low, spaces are flexibly issued according to user preferences and attributes. When using an AI model, the input consists of “parking lot status tensor (N spaces×M features)+congestion score+time series history data,” and the output is a “recommended parking space number” or a “list of candidates with congestion avoidance recommendation scores.” For example, input examples include “vacancy rate: 15%,” “peak prediction: in 10 minutes,” and output examples include “Parking space No. 21 (recommendation score 0.91, congestion avoidance),” etc. The issuing unit automatically adjusts the parameters of the issuing algorithm (e.g., area weights, issuing priority, etc.) based on the congestion score and AI inference results, and immediately issues the optimal parking space number. Furthermore, the issuing unit accumulates historical congestion data and can use time series prediction models (e.g., LSTM, time series regression, etc.) to predict future congestion peaks and optimize issuing strategies in advance. Thus, the issuing unit realizes real-time and predictive congestion avoidance and efficiency improvement, unlike conventional static allocation or manual congestion management, resulting in technical effects such as improved turnover rates for the entire parking lot, enhanced user experience, and alleviation of congestion. Applicable fields include parking lots for large commercial facilities, airports, event venues, urban parking lots, and other parking lots where congestion management is important.

The issuing unit can refer to the usage history of the parking lot and issue the number of a parking space based on past usage patterns. For example, the issuing unit can prioritize frequently used parking spaces based on past usage history. The issuing unit can also analyze past usage patterns and issue parking spaces according to user preferences. Furthermore, the issuing unit can refer to past usage history and issue parking spaces used during specific time periods. For example, the issuing unit prioritizes frequently used parking spaces based on past usage history. The issuing unit can analyze past usage patterns and issue parking spaces according to user preferences. The issuing unit can refer to past usage history and issue parking spaces used during specific time periods. By referring to the usage history of the parking lot, the system can issue optimal parking space numbers based on past usage patterns. Specifically, the issuing unit refers to a user-specific usage history database (e.g., parking date and time, space number used, duration of stay, purpose of use, congestion level, user attributes, etc.) and extracts past usage trends. The issuing unit vectorizes features from usage history (e.g., preferred area, frequently used spaces, trends by day of week and time period, etc.) and inputs them into an AI model (e.g., collaborative filtering, clustering, time series analysis models, etc.). The AI model combines the input history vector with the current parking lot status tensor (N spaces×M features) to infer optimal parking space candidates for each user. For example, input examples include “used No. 12 in 7 out of the last 10 times,” “prefers No. 5 on weekday mornings,” and output examples include “Parking space No. 12 (recommendation score 0.94),” “No. 5 (recommendation score 0.89),” etc. The issuing unit immediately issues the parking space number with the highest recommendation score and notifies the confirmation unit. Furthermore, the issuing unit can analyze time series patterns in usage history and automatically learn optimal allocation strategies for specific time periods or events. Thus, the issuing unit realizes personalized parking space issuing based on each user's history and preferences, unlike conventional uniform allocation or methods relying on human experience, resulting in technical effects such as improved user satisfaction, repeat rate, and parking lot turnover rate. Applicable fields include membership parking lots, commercial facilities, office buildings, hospitals, and other parking lots with frequent repeat users.

The issuing unit can estimate the emotion of the driver and determine the priority of the parking space to be issued based on the estimated emotion of the driver. For example, the issuing unit can estimate the emotion of the driver and determine the priority of the parking space to be issued based on the estimated emotion of the driver. For instance, if the driver is feeling stressed, the issuing unit prioritizes issuing available parking spaces. If the driver is relaxed, the issuing unit can prioritize issuing quiet parking spaces in the back of the parking lot. Furthermore, if the driver is in a hurry, the issuing unit can prioritize issuing parking spaces with easy access. By determining the priority of the parking space to be issued according to the emotion of the driver, the system can reduce the driver's stress and improve the convenience of parking. Emotion estimation is realized, for example, by using an emotion engine or generative AI for emotion estimation functions. Generative AI may include text generation AI (e.g., LLM) or multimodal generative AI, but is not limited to these examples. Some or all of the above-described processing in the issuing unit may be performed using AI or without using AI. For example, the issuing unit can input the driver's face image into generative AI to estimate emotion. Specifically, the issuing unit can input multiple modal data such as driver's face image (e.g., RGB image, cropped face region), voice data (e.g., speech waveform, spectrogram), and text input (e.g., speech recognition results, chat history) into an AI model. The issuing unit uses a multimodal neural network (e.g., integrated CNN+RNN+Transformer) to integrate features extracted from each modality and outputs emotion classification (e.g., stress, relaxation, urgency, etc.) and emotion scores (e.g., stress level 0.88, etc.). For example, input examples include “face image: frowning,” “voice: fast speech, high pitch,” “text: in a hurry,” and output examples include “emotion label: urgency,” “emotion score: 0.91,” etc. The issuing unit dynamically adjusts the priority of the list of available parking spaces based on the estimated emotion label and score. For example, if the stress level is high, “proximity to entrance” is emphasized; if relaxed, “quiet space in the back” is emphasized; if in a hurry, “along the aisle” is emphasized, and the priority is automatically switched. Furthermore, the issuing unit can continuously learn individual optimization by combining emotion estimation results with issuing history and user attributes. Thus, the issuing unit realizes highly accurate emotion estimation and dynamic priority optimization by AI, unlike conventional uniform allocation or subjective human judgment, resulting in technical effects such as improved user experience, stress reduction, and safety. Applicable fields include general parking lots as well as parking lots for hospitals, elderly care facilities, airports, and event venues, where consideration of users' psychological states is required.

The issuing unit can issue, based on weather information of the parking lot, a covered parking space with priority during rainy weather. For example, the issuing unit can consider weather information of the parking lot and issue a covered parking space with priority during rainy weather. For instance, the issuing unit issues a covered parking space with priority during rainy weather. The issuing unit can also issue a parking space with a non-slip surface with priority on snowy days. Furthermore, the issuing unit can issue a parking space with a good view with priority on sunny days. By issuing parking spaces based on weather information of the parking lot, the system can provide optimal parking spaces according to the weather. Specifically, the issuing unit obtains real-time weather data (e.g., rainfall flag, snow depth, temperature, wind speed, etc.) from external weather APIs or weather sensors within the parking lot (e.g., temperature, humidity, rainfall, snow sensors, etc.). The issuing unit combines weather data with the attributes of each parking space in the parking lot (e.g., presence of a roof, floor material, sunlight exposure, landscape score, etc.) to extract optimal parking space candidates. When using an AI model, the input consists of “weather vector+parking lot status tensor (N spaces×M features),” and the output is a “recommended parking space number” or a “list of candidates with weather suitability scores.” For example, input examples include “weather: rain,” “covered spaces: No. 3, 7, 12,” and output examples include “Parking space No. 7 (suitability score 0.97),” etc. The issuing unit dynamically adjusts the weight parameters of the issuing algorithm (e.g., “presence of roof” emphasis, “non-slip” emphasis, “landscape” emphasis, etc.) according to weather conditions to determine the optimal parking space number. Furthermore, the issuing unit accumulates weather history data and can use time series prediction models (e.g., LSTM, etc.) to predict future weather changes and optimize issuing strategies in advance. Thus, the issuing unit realizes real-time and predictive weather-adaptive parking space issuing, unlike conventional static allocation or manual weather response, resulting in technical effects such as improved user satisfaction, safety, and comfort. Applicable fields include outdoor parking lots, commercial facilities, hospitals, event venues, and other parking lots that are susceptible to weather changes.

The issuing unit can issue, based on attribute information of users of the parking lot, a parking space close to facilities for children for families. For example, the issuing unit can consider attribute information of users of the parking lot and issue a parking space close to facilities for children for families. For instance, the issuing unit issues a parking space close to facilities for children for families. The issuing unit can also issue a parking space near the entrance of the parking lot for elderly users. Furthermore, the issuing unit can issue a parking space with easy access for business users. By issuing parking spaces based on attribute information of users of the parking lot, the system can provide parking spaces suitable for each user. Specifically, the issuing unit receives user attribute data (e.g., family composition, age group, purpose of use, presence of disabilities, business use flag, etc.) obtained at the entry gate or during advance reservation as input parameters. The issuing unit vectorizes these attribute data and combines them with the physical feature quantities of each parking space in the parking lot (e.g., distance to facilities for children, barrier-free support, distance from entrance, congestion level, surrounding facility score, etc.) to extract optimal parking space candidates. When using an AI model, the input consists of “user attribute vector+parking lot status tensor (N spaces×M features),” and the output is a “recommended parking space number” or a “list of candidates with attribute suitability scores.” For example, input examples include “family composition: 2 adults+2 children,” “purpose of use: leisure,” “facilities for children: near No. 8, 15, 22,” and output examples include “Parking space No. 8 (suitability score 0.96, 5 m to facilities for children),” “No. 15 (suitability score 0.91),” etc. The issuing unit immediately issues the parking space number with the highest recommendation score and notifies the confirmation unit. Furthermore, the issuing unit can dynamically adjust the weight parameters of the issuing algorithm (e.g., “distance to facilities for children” emphasis, “barrier-free” emphasis, etc.) according to user attributes and usage history, and continuously learn individual optimization. Thus, the issuing unit realizes highly accurate attribute estimation and dynamic allocation optimization by AI, unlike conventional uniform allocation or subjective human judgment, resulting in technical effects such as improved user experience, convenience, and safety. Applicable fields include commercial facilities, theme parks, hospitals, elderly care facilities, event venues, and other parking lots with diverse user attributes and purposes.

The confirmation unit can estimate the emotion of the driver and adjust the method of displaying the number based on the estimated emotion of the driver. For example, the confirmation unit can estimate the emotion of the driver and adjust the method of displaying the number based on the estimated emotion of the driver. For instance, if the driver is feeling stressed, the confirmation unit provides a simple and highly visible display method. If the driver is relaxed, the confirmation unit can provide a display method that includes detailed information. Furthermore, if the driver is in a hurry, the confirmation unit can provide a display method that highlights key points. By adjusting the method of displaying the number according to the emotion of the driver, the system can reduce the driver's stress and improve visibility. Emotion estimation is realized, for example, by using an emotion engine or generative AI for emotion estimation functions. Generative AI may include text generation AI (e.g., LLM) or multimodal generative AI, but is not limited to these examples. Some or all of the above-described processing in the confirmation unit may be performed using AI or without using AI. For example, the confirmation unit can input the driver's face image into generative AI to estimate emotion. Specifically, the confirmation unit can input multiple modal data such as driver's face image (e.g., RGB image, cropped face region, resolution 128×128 pixels), voice data (e.g., speech waveform, spectrogram), and text input (e.g., speech recognition results, chat history) into an AI model. The confirmation unit uses a multimodal neural network (e.g., integrated CNN+RNN+Transformer) to integrate features extracted from each modality and outputs emotion classification (e.g., stress, relaxation, urgency, etc.) and emotion scores (e.g., stress level 0.88, etc.). For example, input examples include “face image: frowning,” “voice: fast speech, high pitch,” “text: in a hurry,” and output examples include “emotion label: urgency,” “emotion score: 0.91,” etc. The confirmation unit dynamically switches the display UI layout, color scheme, font size, amount of information, and notification method (e.g., voice guidance, vibration, etc.) based on the estimated emotion label and score. For example, if the stress level is high, “large font+voice notification+key points only” is used; if relaxed, “detailed information+map-linked display” is used; if in a hurry, “emphasis on shortest route only,” enabling individual optimization. Furthermore, the confirmation unit accumulates the user's past operation history and real-time emotion estimation results, and can continuously learn display optimization algorithms. Thus, the confirmation unit can provide a variety of interfaces optimized for each user, greatly improving visibility, operability, and accessibility compared to conventional single display methods. Applicable fields include general parking lots as well as parking lot systems for airports, hospitals, elderly care facilities, and event venues, which have diverse user groups and usage scenarios.

The confirmation unit can add a function to display the shortest route to the parking space when confirming the number. For example, the confirmation unit can display the shortest route to the parking space when confirming the number. For instance, the confirmation unit displays the shortest route to the parking space when confirming the number. The confirmation unit can also display the congestion status within the parking lot when confirming the number. Furthermore, the confirmation unit can update the vacancy status of the parking space in real time when confirming the number. By displaying the shortest route to the parking space, the driver can efficiently reach the parking space. Specifically, the confirmation unit combines parking lot map data (e.g., node-edge graph structure, coordinate information for each aisle, obstacle, entrance/exit, parking space, etc.) and real-time congestion data (e.g., passability of each aisle, congestion score, etc.), and uses a shortest path search algorithm (e.g., Dijkstra's algorithm, A* algorithm, etc.) to calculate the optimal route from the user's current location to the designated parking space. The confirmation unit displays the calculation results on interfaces such as smartphone applications, in-vehicle displays, and head-up displays, and can also link with voice guidance and AR display. For example, input examples include “current location: Gate A,” “destination: Parking space No. 15,” “congestion: high on aisle B,” and output examples include “route: Gate A→aisle C→No. 15 (required time: 2 minutes),” etc. Furthermore, the confirmation unit can reflect changes in congestion and obstacle information in real time, and automatically recalculate routes and provide detour guidance. Thus, the confirmation unit realizes navigation functions with excellent real-time performance, optimality, and usability, unlike conventional static map displays or manual guidance, resulting in technical effects such as improved movement efficiency within the parking lot, alleviation of congestion, and enhanced user experience. Applicable fields include parking lots for large commercial facilities, airports, event venues, hospitals, and other parking lots with complex structures or frequent congestion.

The confirmation unit can add a function to update the vacancy status of the parking space in real time when confirming the number. For example, the confirmation unit can update the vacancy status of the parking space in real time when confirming the number. For instance, the confirmation unit updates the vacancy status of the parking space in real time when confirming the number. The confirmation unit can also display the congestion status within the parking lot when confirming the number. Furthermore, the confirmation unit can display information about facilities surrounding the parking space when confirming the number. By updating the vacancy status of the parking space in real time, the driver can select a parking space based on the latest information. Specifically, the confirmation unit receives occupancy status data (e.g., binary occupancy flags, object detection labels, timestamps, etc.) collected from sensor networks (e.g., ultrasonic sensors, magnetic sensors, image recognition cameras, etc.) installed in each parking space within the parking lot from the aggregation server in real time. The confirmation unit immediately updates the vacancy status of the designated parking space based on the received data and displays statuses such as “vacant,” “in use,” or “reserved” on the user interface. For example, input examples include “Parking space No. 12: vacant,” “No. 15: in use,” and output examples include “No. 12: displayed in green,” “No. 15: displayed in red,” etc. Furthermore, the confirmation unit can immediately notify users of changes in vacancy status via push notifications or voice guidance, and can automatically reallocate vacant spaces or recalculate routes. Thus, the confirmation unit realizes information provision with excellent real-time performance, accuracy, and usability, unlike conventional static displays or manual information updates, resulting in technical effects such as alleviation of congestion within the parking lot, enhanced user experience, and prevention of incorrect guidance. Applicable fields include parking lots for large commercial facilities, airports, event venues, hospitals, and other parking lots where real-time performance is required.

The confirmation unit can estimate the emotion of the driver and adjust the order of displaying the numbers based on the estimated emotion of the driver. For example, the confirmation unit can estimate the emotion of the driver and adjust the order of displaying the numbers based on the estimated emotion of the driver. For instance, if the driver is feeling stressed, the confirmation unit prioritizes displaying important information. If the driver is relaxed, the confirmation unit can provide a display order that includes detailed information. Furthermore, if the driver is in a hurry, the confirmation unit can provide a display order that highlights key points. By adjusting the order of displaying the numbers according to the emotion of the driver, the system can reduce the driver's stress and improve visibility. Emotion estimation is realized, for example, by using an emotion engine or generative AI for emotion estimation functions. Generative AI may include text generation AI (e.g., LLM) or multimodal generative AI, but is not limited to these examples. Some or all of the above-described processing in the confirmation unit may be performed using AI or without using AI. For example, the confirmation unit can input the driver's face image into generative AI to estimate emotion. Specifically, the confirmation unit can input multiple modal data such as driver's face image (e.g., RGB image, cropped face region), voice data (e.g., speech waveform, spectrogram), and text input (e.g., speech recognition results, chat history) into an AI model. The confirmation unit uses a multimodal neural network (e.g., integrated CNN+RNN+Transformer) to integrate features extracted from each modality and outputs emotion classification (e.g., stress, relaxation, urgency, etc.) and emotion scores (e.g., stress level 0.88, etc.). For example, input examples include “face image: frowning,” “voice: fast speech, high pitch,” “text: in a hurry,” and output examples include “emotion label: urgency,” “emotion score: 0.91,” etc. The confirmation unit dynamically rearranges the priority of display information (e.g., parking space number, shortest route, congestion status, surrounding facility information, etc.) based on the estimated emotion label and score to provide optimal information for the user's situation. For example, if the stress level is high, “parking space number+shortest route” is displayed at the top; if relaxed, “surrounding facility information+detailed guidance” is prioritized; if in a hurry, “simple display of key points only,” enabling individual optimization. Furthermore, the confirmation unit accumulates the user's past operation history and real-time emotion estimation results, and can continuously learn display order optimization algorithms. Thus, the confirmation unit realizes information display optimized for each user, greatly improving visibility, operability, and accessibility compared to conventional fixed information presentation. Applicable fields include general parking lots as well as parking lot systems for airports, hospitals, elderly care facilities, and event venues, which have diverse user groups and usage scenarios.

The confirmation unit can add a function to display the congestion status within the parking lot when confirming the number. For example, the confirmation unit can display the congestion status within the parking lot when confirming the number. For instance, the confirmation unit displays the congestion status within the parking lot when confirming the number. The confirmation unit can also update the vacancy status of the parking space in real time when confirming the number. Furthermore, the confirmation unit can display information about facilities surrounding the parking space when confirming the number. By displaying the congestion status within the parking lot, the driver can select a parking space while avoiding congestion. Specifically, the confirmation unit aggregates real-time data (e.g., occupancy flags for each space, number of entries, number of exits, time information, etc.) collected from sensors within the parking lot (e.g., ultrasonic sensors, image recognition cameras, entry/exit gate counters, etc.) and calculates the overall congestion score of the parking lot (e.g., vacancy rate, area-specific congestion, peak prediction values, etc.). The confirmation unit displays the congestion score as a heat map or color-coded display on the parking lot map, allowing users to intuitively grasp congested areas. For example, input examples include “vacancy rate: 15%,” “congestion in area A: high,” and output examples include “area A: displayed in red,” “area B: displayed in green,” etc. Furthermore, the confirmation unit can reflect changes in congestion status in real time and automatically propose congestion avoidance routes or reallocate vacant spaces. Thus, the confirmation unit realizes congestion information provision with excellent real-time performance, accuracy, and usability, unlike conventional static displays or manual congestion guidance, resulting in technical effects such as alleviation of congestion within the parking lot, enhanced user experience, and prevention of incorrect guidance. Applicable fields include parking lots for large commercial facilities, airports, event venues, hospitals, and other parking lots where congestion management is important.

The confirmation unit can add a function to display information about facilities surrounding the parking space when confirming the number. For example, the confirmation unit can display information about facilities surrounding the parking space when confirming the number. For instance, the confirmation unit displays information about facilities surrounding the parking space when confirming the number. The confirmation unit can also display the congestion status within the parking lot when confirming the number. Furthermore, the confirmation unit can update the vacancy status of the parking space in real time when confirming the number. By displaying information about facilities surrounding the parking space, the driver can more easily plan their actions after parking. Specifically, the confirmation unit refers to a database of surrounding facilities linked to the location information of each parking space within the parking lot (e.g., toilets, elevators, escalators, facilities for children, restaurants, barrier-free facilities, etc.), and automatically extracts the distance and route information from the designated parking space to each facility. The confirmation unit displays the extracted surrounding facility information in a map-linked UI or list format, enabling users to easily plan their movement to their destination after parking. For example, input examples include “Parking space No. 8,” “surrounding facilities: toilet (20 m), elevator (15 m),” and output examples include “No. 8: 20 m to toilet, 15 m to elevator,” etc. Furthermore, the confirmation unit can simultaneously display facility congestion status, available hours, barrier-free support status, etc. Thus, the confirmation unit realizes technical effects such as supporting users' action planning, improving convenience, and enhancing accessibility, unlike conventional simple parking space number displays. Applicable fields include parking lots for commercial facilities, hospitals, elderly care facilities, event venues, and other parking lots where use of surrounding facilities is important.

The allocation unit can estimate the emotion of the driver and adjust the allocation criteria for parking spaces based on the estimated emotion of the driver. For example, the allocation unit can estimate the emotion of the driver and adjust the allocation criteria for parking spaces based on the estimated emotion of the driver. For instance, if the driver is feeling stressed, the allocation unit prioritizes allocating a parking space near the entrance of the parking lot. If the driver is relaxed, the allocation unit can prioritize allocating a quiet parking space in the back of the parking lot. Furthermore, if the driver is in a hurry, the allocation unit can prioritize allocating a parking space with easy access. By adjusting the allocation criteria for parking spaces according to the emotion of the driver, the system can reduce the driver's stress and improve the convenience of parking. Emotion estimation is realized, for example, by using an emotion engine or generative AI for emotion estimation functions. Generative AI may include text generation AI (e.g., LLM) or multimodal generative AI, but is not limited to these examples. Some or all of the above-described processing in the allocation unit may be performed using AI or without using AI. For example, the allocation unit can input the driver's face image into generative AI to estimate emotion. Specifically, the allocation unit can input multiple modal data such as driver's face image (e.g., RGB image, cropped face region), voice data (e.g., speech waveform, spectrogram), and text input (e.g., speech recognition results, chat history) into an AI model. The allocation unit uses a multimodal neural network (e.g., integrated CNN+RNN+Transformer) to integrate features extracted from each modality and outputs emotion classification (e.g., stress, relaxation, urgency, etc.) and emotion scores (e.g., stress level 0.88, etc.). For example, input examples include “face image: frowning,” “voice: fast speech, high pitch,” “text: in a hurry,” and output examples include “emotion label: urgency,” “emotion score: 0.91,” etc. The allocation unit dynamically adjusts the weight parameters of the parking space allocation algorithm (e.g., “distance from entrance” emphasis, “quietness” emphasis, etc.) based on the estimated emotion label and score to extract optimal parking space candidates. For example, if the stress level is high, “proximity to entrance” is emphasized; if relaxed, “quiet space in the back” is emphasized; if in a hurry, “entrance or along the aisle” is emphasized, and the allocation criteria are automatically switched. Furthermore, the allocation unit can continuously learn individual optimization by combining emotion estimation results with issuing history and user attributes. Thus, the allocation unit realizes highly accurate emotion estimation and dynamic allocation optimization by AI, unlike conventional uniform allocation or subjective human judgment, resulting in technical effects such as improved user experience, stress reduction, and safety. Applicable fields include general parking lots as well as parking lots for hospitals, elderly care facilities, airports, and event venues, where consideration of users' psychological states is required.

The allocation unit can refer to the usage history of the parking lot when allocating and allocate the optimal parking space. For example, the allocation unit can prioritize frequently used parking spaces based on past usage history. The allocation unit can also analyze past usage patterns and allocate parking spaces according to user preferences. Furthermore, the allocation unit can refer to past usage history and allocate parking spaces used during specific time periods. For example, the allocation unit prioritizes frequently used parking spaces based on past usage history. The allocation unit can analyze past usage patterns and allocate parking spaces according to user preferences. The allocation unit can refer to past usage history and allocate parking spaces used during specific time periods. By referring to the usage history of the parking lot, the system can allocate optimal parking spaces based on past usage patterns. Specifically, the allocation unit refers to a user-specific usage history database (e.g., parking date and time, space number used, duration of stay, purpose of use, congestion level, user attributes, etc.) and extracts past usage trends. The allocation unit vectorizes features from usage history (e.g., preferred area, frequently used spaces, trends by day of week and time period, etc.) and inputs them into an AI model (e.g., collaborative filtering, clustering, time series analysis models, etc.). The AI model combines the input history vector with the current parking lot status tensor (N spaces×M features) to infer optimal parking space candidates for each user. For example, input examples include “used No. 12 in 7 out of the last 10 times,” “prefers No. 5 on weekday mornings,” and output examples include “Parking space No. 12 (recommendation score 0.94),” “No. 5 (recommendation score 0.89),” etc. The allocation unit immediately assigns the parking space with the highest recommendation score and notifies the issuing unit and confirmation unit. Furthermore, the allocation unit can analyze time series patterns in usage history and automatically learn optimal allocation strategies for specific time periods or events. Thus, the allocation unit realizes personalized parking space allocation based on each user's history and preferences, unlike conventional uniform allocation or methods relying on human experience, resulting in technical effects such as improved user satisfaction, repeat rate, and parking lot turnover rate. Applicable fields include membership parking lots, commercial facilities, office buildings, hospitals, and other parking lots with frequent repeat users.

The allocation unit is capable of analyzing the congestion status of the parking lot in real time during allocation and allocating the optimal parking space. For example, the allocation unit can monitor the congestion status of the parking lot in real time and immediately allocate available parking spaces. Furthermore, the allocation unit can adjust the allocation order of parking spaces according to the degree of congestion in the parking lot. Additionally, the allocation unit can analyze the congestion status of the parking lot and allocate parking spaces to avoid congestion. For instance, the allocation unit monitors the congestion status of the parking lot in real time and immediately allocates available parking spaces. The allocation unit can adjust the allocation order of parking spaces according to the degree of congestion in the parking lot. The allocation unit can analyze the congestion status of the parking lot and allocate parking spaces to avoid congestion. By analyzing the congestion status of the parking lot in real time, the optimal parking space can be allocated. Specifically, the allocation unit aggregates real-time data collected from various sensors within the parking lot (e.g., ultrasonic sensors, image recognition cameras, entry/exit gate counters), such as occupancy flags for each space, number of entries, number of exits, and time information, and calculates an overall congestion score for the parking lot (e.g., vacancy rate, area-specific congestion, peak prediction values). Based on the congestion score, the allocation unit dynamically adjusts the assignment order and criteria for the list of available parking spaces. For example, when congestion is high, spaces near the entrance/exit are prioritized to reduce travel distance and the risk of traffic jams within the lot. When congestion is low, spaces can be flexibly assigned according to user preferences and attributes. When using an AI model, the input consists of a “parking lot status tensor (N spaces×M features)+congestion score+time-series history data,” and the output is a “recommended parking space number” or a “candidate list with congestion avoidance recommendation scores.” For example, input examples include “vacancy rate: 15%” and “peak prediction: in 10 minutes,” and output examples include “Parking space No. 21 (recommendation score 0.91, congestion avoidance).” The allocation unit automatically adjusts parameters of the assignment algorithm (e.g., area weights, assignment priorities) based on the congestion score and AI inference results to immediately assign the optimal parking space. Furthermore, the allocation unit accumulates historical congestion data and uses time-series prediction models (e.g., LSTM, time-series regression) to predict future congestion peaks and optimize allocation strategies in advance. As a result, the allocation unit achieves real-time and predictive congestion avoidance and efficiency improvements, unlike conventional static allocation or manual congestion management, thereby providing technical effects such as improved turnover rate of the parking lot, enhanced user experience, and alleviation of congestion. Applicable fields include all parking lots where congestion management is important, such as large commercial facilities, airports, event venues, and urban parking lots.

The allocation unit is capable of estimating the emotion of the driver and adjusting the allocation order of parking spaces based on the estimated emotion. For example, the allocation unit can estimate the emotion of the driver and adjust the allocation order of parking spaces according to the estimated emotion. For instance, if the driver is feeling stressed, the allocation unit prioritizes the allocation of available parking spaces. If the driver is relaxed, the allocation unit can prioritize quiet parking spaces located deeper within the parking lot. Furthermore, if the driver is in a hurry, the allocation unit can prioritize parking spaces with easy access. By adjusting the allocation order of parking spaces according to the driver's emotion, the driver's stress can be reduced and the convenience of parking can be improved. Emotion estimation is realized using, for example, an emotion engine or generative AI with emotion estimation functions. Generative AI may include text generation AI (e.g., LLM) or multimodal generative AI, but is not limited to these examples. Some or all of the above-described processes in the allocation unit may be performed using AI or without AI. For example, the allocation unit can input the driver's facial image into generative AI to estimate emotion. Specifically, the allocation unit inputs multimodal data such as the driver's facial image (e.g., RGB image, cropped face region), voice data (e.g., speech waveform, spectrogram), and text input (e.g., speech recognition results, chat history) into an AI model. The allocation unit uses a multimodal neural network (e.g., integrated CNN+RNN+Transformer) to integrate features extracted from each modality and outputs emotion classification (e.g., stress, relaxation, urgency) and emotion scores (e.g., stress level 0.88). For example, input examples include “facial image: frown,” “voice: fast and high-pitched,” “text: in a hurry,” and output examples include “emotion label: urgency,” “emotion score: 0.91.” The allocation unit dynamically adjusts the priority of the available parking space list based on the estimated emotion label and score. For example, when the stress level is high, priority is given to spaces near the entrance/exit; when relaxed, priority is given to quiet spaces deeper in the lot; when in a hurry, priority is given to spaces along the aisle, and so on, with priorities automatically switched. Furthermore, the allocation unit can continuously learn individual optimization by combining emotion estimation results with issuance history and user attributes. As a result, the allocation unit achieves high-precision emotion estimation and dynamic priority optimization by AI, unlike conventional uniform allocation or subjective human judgment, thereby providing technical effects such as improved user experience, stress reduction, and enhanced safety. Applicable fields include not only general parking lots but also parking lots where consideration of users' psychological states is necessary, such as hospitals, elderly care facilities, airports, and event venues.

The allocation unit is capable of prioritizing the allocation of covered parking spaces during rainy weather based on weather information of the parking lot at the time of allocation. For example, the allocation unit can consider the weather information of the parking lot and prioritize the allocation of covered parking spaces during rainy weather. For instance, the allocation unit prioritizes the allocation of covered parking spaces during rainy weather. Additionally, during snowy days, the allocation unit can prioritize the allocation of parking spaces with non-slip surfaces. Furthermore, during sunny weather, the allocation unit can prioritize the allocation of parking spaces with good views. By allocating parking spaces based on weather information of the parking lot, optimal parking spaces suitable for the weather can be provided. Specifically, the allocation unit obtains real-time weather data (e.g., rainfall flag, snow depth, temperature, wind speed) from external weather APIs or weather sensors within the parking lot (e.g., temperature, humidity, rainfall, snow sensors). The allocation unit combines weather data with attributes of each parking space in the lot (e.g., presence of roof, floor material, sunlight exposure, landscape score) to extract optimal parking space candidates. When using an AI model, the input consists of a “weather vector+parking lot status tensor (N spaces×M features),” and the output is a “recommended parking space number” or a “candidate list with weather suitability scores.” For example, input examples include “weather: rain,” “covered spaces: No. 3, 7, 12,” and output examples include “Parking space No. 7 (suitability score 0.97).” The allocation unit dynamically adjusts weighting parameters of the assignment algorithm (e.g., emphasis on “presence of roof,” “non-slip surface,” “landscape”) according to weather conditions to determine the optimal parking space. Furthermore, the allocation unit accumulates weather history data and uses time-series prediction models (e.g., LSTM) to predict future weather changes and optimize allocation strategies in advance. As a result, the allocation unit achieves real-time and predictive weather-adaptive parking space allocation, unlike conventional static allocation or manual weather response, thereby providing technical effects such as improved user satisfaction, safety, and comfort. Applicable fields include all parking lots susceptible to weather changes, such as outdoor parking lots, commercial facilities, hospitals, and event venues.

The allocation unit is capable of allocating parking spaces close to facilities for children to families based on user attribute information of the parking lot at the time of allocation. For example, the allocation unit can consider user attribute information of the parking lot and allocate parking spaces close to facilities for children to families. For instance, the allocation unit allocates parking spaces close to facilities for children to families. Additionally, the allocation unit can allocate parking spaces close to the entrance of the parking lot to elderly users. Furthermore, the allocation unit can allocate parking spaces with easy access to business users. By allocating parking spaces based on user attribute information of the parking lot, parking spaces suitable for each user can be provided. Specifically, the allocation unit receives user attribute data (e.g., family composition, age group, purpose of use, presence of disabilities, business use flag) obtained at the entry gate or during advance reservation as input parameters. The allocation unit vectorizes these attribute data and combines them with physical features of each parking space in the parking lot (e.g., distance to facilities for children, barrier-free support, distance from entrance/exit, congestion level, surrounding facility score) to extract optimal parking space candidates. When using an AI model, the input consists of a “user attribute vector+parking lot status tensor (N spaces×M features),” and the output is a “recommended parking space number” or a “candidate list with attribute suitability scores.” For example, input examples include “family composition: 2 adults+2 children,” “purpose: leisure,” “facilities for children: near No. 8, 15, 22,” and output examples include “Parking space No. 8 (suitability score 0.96, 5 m to facilities for children),” “No. 15 (suitability score 0.91).” The allocation unit immediately assigns the parking space with the highest recommendation score and notifies the issuing unit and confirmation unit. Furthermore, the allocation unit can dynamically adjust weighting parameters of the assignment algorithm (e.g., emphasis on “distance to facilities for children,” “barrier-free support”) according to user attributes and usage history, and continuously learn individual optimization. As a result, the allocation unit achieves high-precision attribute estimation and dynamic allocation optimization by AI, unlike conventional uniform allocation or subjective human judgment, thereby providing technical effects such as improved user experience, convenience, and safety. Applicable fields include all parking lots with diverse user attributes and purposes, such as commercial facilities, theme parks, hospitals, elderly care facilities, and event venues.

The system according to the embodiment is not limited to the examples described above and can be variously modified as follows. Specifically, the system allows for diverse variations in AI model architecture and training methods, sensor network configuration, data flow, user interface, allocation algorithms, and more. The system can employ not only a single neural network as the AI model but also collaborative or ensemble learning of multiple models (e.g., CNN for attribute classification, LSTM for time-series prediction, Transformer for recommendation). As the sensor network, the system can combine various sensors such as ultrasonic sensors, magnetic sensors, image recognition cameras, LiDAR, and beacons to achieve high-precision detection of parking lot status. As the user interface, the system can combine various output means such as smartphone applications, in-vehicle displays, AR displays, voice guidance, and projection mapping. As the allocation algorithm, the system can select from various methods such as rule-based, decision tree, random forest, neural network, and reinforcement learning. Furthermore, the system can combine distributed processing among cloud servers, edge servers, and local terminals, as well as anonymization and encryption processing for data privacy protection. As a result, the system enables flexible system design according to the scale of the parking lot, user demographics, and operational form, thereby providing technical effects such as improved scalability, adaptability, security, and user experience. Applicable fields include all types of parking lot systems, such as urban parking lots, suburban commercial facilities, hospitals, airports, event venues, apartment parking lots, and car-sharing bases.

The issuing unit is capable of accepting advance reservations for parking spaces before the user arrives at the parking lot. For example, the issuing unit allows users to reserve available parking spaces before arrival via a smartphone application or website. Additionally, the issuing unit can update the information of reserved parking spaces in real time and notify other users that the space is reserved. Furthermore, the issuing unit can make the information of reserved parking spaces available for confirmation at the entrance of the parking lot, enabling users to park smoothly. As a result, users can secure parking spaces in advance and avoid congestion within the parking lot. Specifically, the issuing unit receives reservation request data such as user ID, desired date and time, vehicle attributes, and purpose of use from the reservation interface of a smartphone application or website. The issuing unit refers to the real-time parking lot status tensor (N spaces×M features) and reservation history database to extract candidate available spaces for reservation. When using an AI model, the input consists of a “user attribute vector+reservation request vector+parking lot status tensor,” and the output is a “recommended parking space number for reservation” or a “candidate list with reservation suitability scores.” For example, input examples include “desired date and time: 2024/7/1 10:00-12:00,” “vehicle type: minivan,” “purpose: family leisure,” and output examples include “Parking space No. 15 (suitability score 0.95, near facilities for children).” After reservation is confirmed, the issuing unit immediately updates the status of the corresponding parking space to “reserved” and excludes it from other users' reservation candidates. Furthermore, the issuing unit links reservation information to the entry gate and confirmation unit interfaces to ensure users can park smoothly upon arrival. As a result, the issuing unit achieves an advance reservation function with excellent real-time performance, optimality, and usability, unlike conventional first-come-first-served allocation or manual reservation management, thereby providing technical effects such as alleviation of congestion within the parking lot, improved user experience, and prevention of erroneous reservations. Applicable fields include all parking lots with high advance reservation needs, such as commercial facilities, airports, event venues, hospitals, and apartment buildings.

The confirmation unit is capable of displaying safety information around the parking space when confirming the parking space number. For example, the confirmation unit can display the location of security cameras installed around the parking space and the location of emergency exits available in case of emergency. Additionally, the confirmation unit can provide information on the lighting conditions around the parking space and safety information for nighttime. Furthermore, the confirmation unit can display information on past crimes or accidents that occurred around the parking space, enabling users to park safely. As a result, users can check safety information about the parking space in advance and park with peace of mind. Specifically, the confirmation unit refers to a safety information database linked to the location information of each parking space within the parking lot (e.g., security camera installation locations, emergency exit coordinates, lighting intensity map, history of past crimes and accidents) and automatically extracts safety-related information around the specified parking space. The confirmation unit displays the extracted safety information in a map-linked UI or list format, allowing users to intuitively grasp safety before parking. For example, input examples include “Parking space No. 8,” “Security camera: 10 m ahead,” “Emergency exit: 15 m,” “Nighttime lighting: strong,” and output examples include “No. 8: near security camera, 15 m to emergency exit, strong nighttime lighting.” Furthermore, the confirmation unit can display a heat map of past crime and accident history and provide warnings for high-risk areas. As a result, the confirmation unit achieves technical effects such as enhanced safety, peace of mind, and risk avoidance support, unlike conventional simple parking space number displays. Applicable fields include all parking lots where safety is important, such as commercial facilities, hospitals, elderly care facilities, apartment buildings, and event venues.

The allocation unit is capable of adjusting the priority of parking spaces based on the specific membership status of users of the parking lot. For example, the allocation unit can prioritize the assignment of parking spaces near the entrance of the parking lot for VIP members or regular users. Additionally, the allocation unit can prioritize the assignment of wider parking spaces or locations with easy access for users with specific membership status. Furthermore, the allocation unit can provide discounts or benefits on parking fees according to membership status. As a result, users can receive preferential treatment according to their membership status, making parking more comfortable. Specifically, the allocation unit receives user membership status information (e.g., VIP, Gold, Silver, General) as input parameters and combines it with physical features of each parking space in the parking lot (e.g., distance from entrance/exit, space width, barrier-free support) to extract priority assignment candidates. When using an AI model, the input consists of a “membership status vector+parking lot status tensor (N spaces×M features),” and the output is a “priority parking space number” or a “candidate list with benefit scores.” For example, input examples include “membership status: VIP,” “purpose: business,” and output examples include “Parking space No. 2 (benefit score 0.98, 5 m to entrance/exit).” After assignment is confirmed, the allocation unit links membership benefit information (e.g., discount coupons, benefit notifications) to the confirmation unit and notifies the user. As a result, the allocation unit achieves a real-time, optimal, and highly usable membership benefit function, unlike conventional uniform allocation or manual membership management, thereby providing technical effects such as improved user satisfaction, repeat rate, and parking lot turnover rate. Applicable fields include all parking lots where membership management is important, such as membership-based parking lots, commercial facilities, office buildings, and hospitals.

The issuing unit is capable of notifying the position of the parking space by voice guidance when the user arrives at the parking space. For example, the issuing unit can provide voice guidance on the position of the parking space via a smartphone application or in-vehicle navigation system. Additionally, the issuing unit can use speakers within the parking lot to provide voice guidance on the position of the parking space. Furthermore, when guiding the position of the parking space, the issuing unit can also provide information on the congestion status within the parking lot and the shortest route. As a result, users can smoothly reach the parking space using voice guidance. Specifically, the issuing unit calculates the optimal route from the user's current location to the specified parking space based on map data and real-time congestion data within the parking lot, and generates guidance voice using a speech synthesis engine (e.g., TTS, neural vocoder). The issuing unit distributes the generated voice data to interfaces such as smartphone applications, in-vehicle navigation, and in-lot speakers, providing real-time guidance to users. For example, input examples include “Current location: Gate A,” “Destination: Parking space No. 15,” “Congestion: High on corridor B,” and output examples include “Route: Gate A→Corridor C→No. 15 (2 minutes required)” plus “Voice guidance: Please turn right.” Furthermore, the issuing unit can automatically update the voice guidance content according to changes in congestion status or obstacle information, and provide route re-guidance or alerts. As a result, the issuing unit achieves a voice navigation function with excellent real-time performance, optimality, and usability, unlike conventional static map displays or manual guidance, thereby providing technical effects such as improved movement efficiency within the parking lot, alleviation of congestion, and enhanced user experience. Applicable fields include all parking lots with complex structures or prone to congestion, such as large commercial facilities, airports, event venues, and hospitals.

The issuing unit is capable of estimating the emotion of the driver and adjusting the lighting of the parking space based on the estimated emotion. For example, if the driver is feeling stressed, the issuing unit can brighten the lighting of the parking space to provide a sense of security. If the driver is relaxed, the issuing unit can soften the lighting to create a calm atmosphere. Furthermore, if the driver is in a hurry, the issuing unit can make the lighting blink to enhance visibility. By adjusting the lighting of the parking space according to the driver's emotion, the convenience and safety of parking can be improved. Specifically, the issuing unit inputs multimodal data such as the driver's facial image, voice data, and text input into an AI model to output emotion classification (e.g., stress, relaxation, urgency) and emotion scores. For example, input examples include “facial image: frown,” “voice: fast,” “text: in a hurry,” and output examples include “emotion label: stress,” “emotion score: 0.92.” Based on the estimated emotion label and score, the issuing unit sends control signals to the lighting control module of the parking space (e.g., LED lighting, dimmer, blinking control circuit) to dynamically adjust brightness, color temperature, blinking pattern, etc. For example, when the stress level is high, “brightness 100%+white light”; when relaxed, “brightness 60%+warm color”; when in a hurry, “blinking+high brightness,” and so on, allowing for individual optimization. Furthermore, the issuing unit can continuously learn optimization algorithms by combining lighting control history and user attributes. As a result, the issuing unit achieves high-precision emotion estimation and dynamic lighting optimization by AI, unlike conventional uniform lighting control or manual adjustment, thereby providing technical effects such as improved user experience, safety, and comfort. Applicable fields include all parking lots where lighting environment is important, such as commercial facilities, hospitals, elderly care facilities, and event venues.

The issuing unit is capable of displaying the position of the parking space using AR (augmented reality) technology when the user arrives at the parking space. For example, the issuing unit can enable the position of the parking space to be displayed in AR when the user points a camera within the parking lot via a smartphone application. Additionally, the issuing unit can use in-vehicle displays to display the position of the parking space in AR. Furthermore, when displaying the position of the parking space, the issuing unit can also provide information on congestion status and the shortest route within the parking lot in AR. As a result, users can intuitively grasp the position of the parking space using AR technology and park smoothly. Specifically, the issuing unit controls an AR rendering module that overlays the position of the parking space, route, congestion areas, etc., on the camera image of the user terminal based on map data, parking space coordinates, and congestion data within the parking lot. The issuing unit tracks the user's current position, orientation, and movement path in real time and generates optimal AR guidelines and icons. For example, input examples include “Current location: Gate A,” “Destination: Parking space No. 15,” “Congestion: High on corridor B,” and output examples include “Arrow to No. 15 and congestion area highlighted in red on camera image.” Furthermore, the issuing unit can customize AR display content according to user attributes and usage history to optimize visibility, operability, and accessibility. As a result, the issuing unit achieves intuitive, real-time, and individually optimized AR navigation functions, unlike conventional static map displays or manual guidance, thereby providing technical effects such as improved movement efficiency within the parking lot, alleviation of congestion, and enhanced user experience. Applicable fields include all parking lots with complex structures or prone to congestion, such as large commercial facilities, airports, event venues, and hospitals.

The issuing unit is capable of guiding the position of the parking space using a drone when the user arrives at the parking space. For example, the issuing unit can use drones deployed within the parking lot to lead the user's vehicle and guide it to the parking space. Additionally, the issuing unit can provide real-time video of the parking space position through cameras mounted on the drone. Furthermore, the issuing unit can use drones to provide information on congestion status and the shortest route within the parking lot. As a result, users can smoothly reach the parking space using drones. Specifically, the issuing unit uses map data, parking space coordinates, and congestion data within the parking lot to calculate the optimal route from the user's vehicle's current position to the specified parking space using an autonomous drone flight control module (e.g., SLAM, obstacle avoidance algorithms) and guides the drone. The issuing unit streams real-time video from the drone's camera to user terminals or in-lot displays and overlays route guides and congestion areas on the video. For example, input examples include “Current location: Gate A,” “Destination: Parking space No. 15,” “Congestion: High on corridor B,” and output examples include “Arrow to No. 15 and congestion area highlighted in red on drone video.” Furthermore, the issuing unit can customize the drone's flight path and guidance content according to user attributes and usage history to optimize visibility, safety, and usability. As a result, the issuing unit achieves real-time, intuitive, and individually optimized drone navigation functions, unlike conventional static map displays or manual guidance, thereby providing technical effects such as improved movement efficiency within the parking lot, alleviation of congestion, and enhanced user experience. Applicable fields include all parking lots with complex structures or prone to congestion, such as large commercial facilities, airports, event venues, and hospitals.

The issuing unit is capable of estimating the emotion of the driver and adjusting the temperature of the parking space based on the estimated emotion. For example, if the driver is feeling stressed, the issuing unit can adjust the temperature of the parking space to a comfortable level to help the driver relax. If the driver is relaxed, the issuing unit can set the temperature of the parking space slightly lower to provide a refreshing feeling. Furthermore, if the driver is in a hurry, the issuing unit can appropriately adjust the temperature of the parking space to provide a comfortable environment. By adjusting the temperature of the parking space according to the driver's emotion, the convenience and comfort of parking can be improved. Specifically, the issuing unit inputs multimodal data such as the driver's facial image, voice data, and text input into an AI model to output emotion classification (e.g., stress, relaxation, urgency) and emotion scores. For example, input examples include “facial image: frown,” “voice: fast,” “text: in a hurry,” and output examples include “emotion label: stress,” “emotion score: 0.92.” Based on the estimated emotion label and score, the issuing unit sends control signals to the temperature control module of the parking space (e.g., floor heating, blower, air conditioning equipment) to dynamically adjust the temperature setting. For example, when the stress level is high, “temperature 24° C.”; when relaxed, “temperature 22° C.”; when in a hurry, “temperature 23° C.,” and so on, allowing for individual optimization. Furthermore, the issuing unit can continuously learn optimization algorithms by combining temperature control history and user attributes. As a result, the issuing unit achieves high-precision emotion estimation and dynamic temperature optimization by AI, unlike conventional uniform temperature control or manual adjustment, thereby providing technical effects such as improved user experience, comfort, and safety. Applicable fields include all parking lots where temperature environment is important, such as commercial facilities, hospitals, elderly care facilities, and event venues.

The issuing unit is capable of displaying the position of the parking space using projection mapping when the user arrives at the parking space. For example, the issuing unit can use projection mapping on walls or floors within the parking lot to display the position of the parking space. Additionally, the issuing unit can use projection mapping to display information on congestion status and the shortest route within the parking lot. Furthermore, the issuing unit can use projection mapping to display information about surrounding facilities and safety information around the parking space. As a result, users can intuitively grasp the position of the parking space using projection mapping and park smoothly. Specifically, the issuing unit uses map data, parking space coordinates, and congestion data within the parking lot to control a projection mapping module (e.g., high-brightness projector, real-time rendering engine) to overlay the position of the parking space, route, congestion areas, surrounding facilities, and safety information on walls or floors. The issuing unit tracks the user's current position and arrival timing to automatically generate optimal display content, timing, and layout. For example, input examples include “Current location: Gate A,” “Destination: Parking space No. 15,” “Congestion: High on corridor B,” and output examples include “Arrow to No. 15 on the floor, congestion area highlighted in red, emergency exit guidance.” Furthermore, the issuing unit can customize projection content according to user attributes and usage history to optimize visibility, operability, and accessibility. As a result, the issuing unit achieves intuitive, real-time, and individually optimized projection navigation functions, unlike conventional static map displays or manual guidance, thereby providing technical effects such as improved movement efficiency within the parking lot, alleviation of congestion, and enhanced user experience. Applicable fields include all parking lots with complex structures or prone to congestion, such as large commercial facilities, airports, event venues, and hospitals.

The issuing unit is capable of estimating the emotion of the driver and adjusting the acoustic environment of the parking space based on the estimated emotion. For example, if the driver is feeling stressed, the issuing unit can play relaxing music around the parking space. If the driver is relaxed, the issuing unit can play natural sounds around the parking space. Furthermore, if the driver is in a hurry, the issuing unit can play alert sounds around the parking space. By adjusting the acoustic environment of the parking space according to the driver's emotion, the convenience and comfort of parking can be improved. Specifically, the issuing unit inputs multimodal data such as the driver's facial image, voice data, and text input into an AI model to output emotion classification (e.g., stress, relaxation, urgency) and emotion scores. For example, input examples include “facial image: frown,” “voice: fast,” “text: in a hurry,” and output examples include “emotion label: stress,” “emotion score: 0.92.” Based on the estimated emotion label and score, the issuing unit sends control signals to the acoustic control module around the parking space (e.g., speakers, acoustic signal processing devices) to dynamically adjust playback sources (e.g., relaxing music, natural sounds, alert sounds), volume, and playback timing. For example, when the stress level is high, “healing music+moderate volume”; when relaxed, “birdsong+low volume”; when in a hurry, “alert sound+high volume,” and so on, allowing for individual optimization. Furthermore, the issuing unit can continuously learn optimization algorithms by combining acoustic control history and user attributes. As a result, the issuing unit achieves high-precision emotion estimation and dynamic acoustic optimization by AI, unlike conventional uniform acoustic control or manual adjustment, thereby providing technical effects such as improved user experience, comfort, and safety. Applicable fields include all parking lots where acoustic environment is important, such as commercial facilities, hospitals, elderly care facilities, and event venues.

The following is a brief explanation of the processing flow of Example of the Embodiment. Specifically, the system collects real-time parking space occupancy data from sensor networks and camera image analysis devices within the parking lot and generates a parking lot status tensor (N spaces×M features) on an aggregation server. The issuing unit receives input parameters such as vehicle ID at entry gate, driver attributes, usage history, weather information, and congestion score, and infers optimal parking space candidates using AI models (e.g., decision tree, random forest, neural network) or rule-based algorithms. The confirmation unit immediately displays the parking space number and candidate list with recommendation scores received from the issuing unit on multiple interfaces such as paper tickets, smartphone applications, and in-vehicle displays, and dynamically optimizes display methods, order, and layout according to user attributes and emotion estimation results. The allocation unit dynamically adjusts allocation criteria and priorities for parking spaces based on vehicle attributes, driver attributes, usage history, congestion status, and weather information, and immediately assigns the optimal parking space. Furthermore, the system accumulates time-series data of usage history and congestion status and continuously executes future prediction and individual optimization learning using AI models. As a result, the system achieves parking space guidance processing with excellent real-time performance, optimality, personalization, and scalability, unlike conventional manual guidance or simple vacant space allocation, thereby providing technical effects such as improved turnover rate of the parking lot, enhanced user experience, alleviation of congestion, and improved safety. Applicable fields include all parking lots with complex structures or diverse user demographics, such as large commercial facilities, airports, event venues, hospitals, and elderly care facilities.

Step 1: The issuing unit immediately issues the number of an available parking space within the parking lot. For example, upon entry into the parking lot, the number of an available parking space can be issued within a few seconds. Step 2: The confirmation unit confirms the number issued by the issuing unit. For example, the confirmation unit can confirm the number via a ticket, a smartphone application, or a monitor of the vehicle. Step 3: The allocation unit allocates the number of the parking space according to the vehicle type and the age or skill of the driver. For example, a wide parking space or a location with easy access is assigned to large vehicles or drivers who are inexperienced in driving. Specifically, the issuing unit collects real-time parking space occupancy data from sensor networks and camera image analysis devices within the parking lot and generates a parking lot status tensor (N spaces×M features) on an aggregation server. The issuing unit receives input parameters such as vehicle ID at entry gate, driver attributes, usage history, weather information, and congestion score, and infers optimal parking space candidates using AI models (e.g., decision tree, random forest, neural network) or rule-based algorithms. The confirmation unit immediately displays the parking space number and candidate list with recommendation scores received from the issuing unit on multiple interfaces such as paper tickets, smartphone applications, and in-vehicle displays, and dynamically optimizes display methods, order, and layout according to user attributes and emotion estimation results. The allocation unit dynamically adjusts allocation criteria and priorities for parking spaces based on vehicle attributes, driver attributes, usage history, congestion status, and weather information, and immediately assigns the optimal parking space. Furthermore, the system accumulates time-series data of usage history and congestion status and continuously executes future prediction and individual optimization learning using AI models. As a result, the system achieves parking space guidance processing with excellent real-time performance, optimality, personalization, and scalability, unlike conventional manual guidance or simple vacant space allocation, thereby providing technical effects such as improved turnover rate of the parking lot, enhanced user experience, alleviation of congestion, and improved safety. Applicable fields include all parking lots with complex structures or diverse user demographics, such as large commercial facilities, airports, event venues, hospitals, and elderly care facilities.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL:https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned issuing unit, confirmation unit, and allocation unit is implemented by at least one of, for example, the smart device 14 and the data processing apparatus 12. For example, the issuing unit is implemented by a control unit 46A of the smart device 14 and immediately issues the number of an available parking space upon entry into the parking lot. The confirmation unit can confirm the number using, for example, a display 40A of the smart device 14 or a smartphone application. The allocation unit is implemented, for example, by a specific processing unit 290 of the data processing apparatus 12 and allocates the number of the parking space according to the vehicle type and the age or skill of the driver. The correspondence between each unit and the apparatus or control unit is not limited to the examples described above and various modifications are possible.

### Second Embodiment

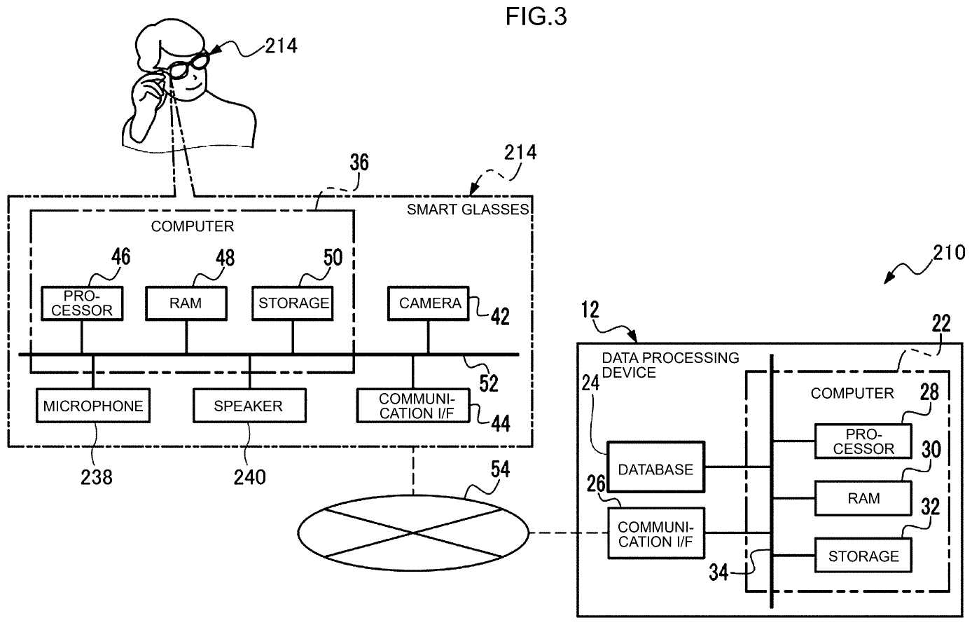

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

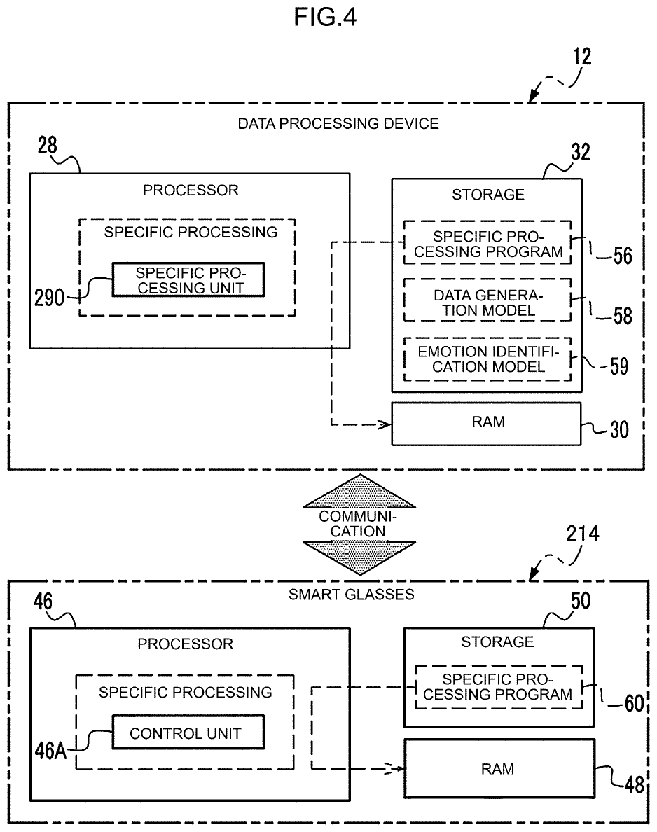

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned issuing unit, confirmation unit, and allocation unit is implemented by at least one of, for example, the smart glasses 214 and the data processing apparatus 12. For example, the issuing unit is implemented by a control unit 46A of the smart glasses 214 and immediately issues the number of an available parking space upon entry into the parking lot. The confirmation unit can confirm the number using, for example, a display of the smart glasses 214 or a smartphone application. The allocation unit is implemented, for example, by a specific processing unit 290 of the data processing apparatus 12 and allocates the number of the parking space according to the vehicle type and the age or skill of the driver. The correspondence between each unit and the apparatus or control unit is not limited to the examples described above and various modifications are possible.

### Third Embodiment

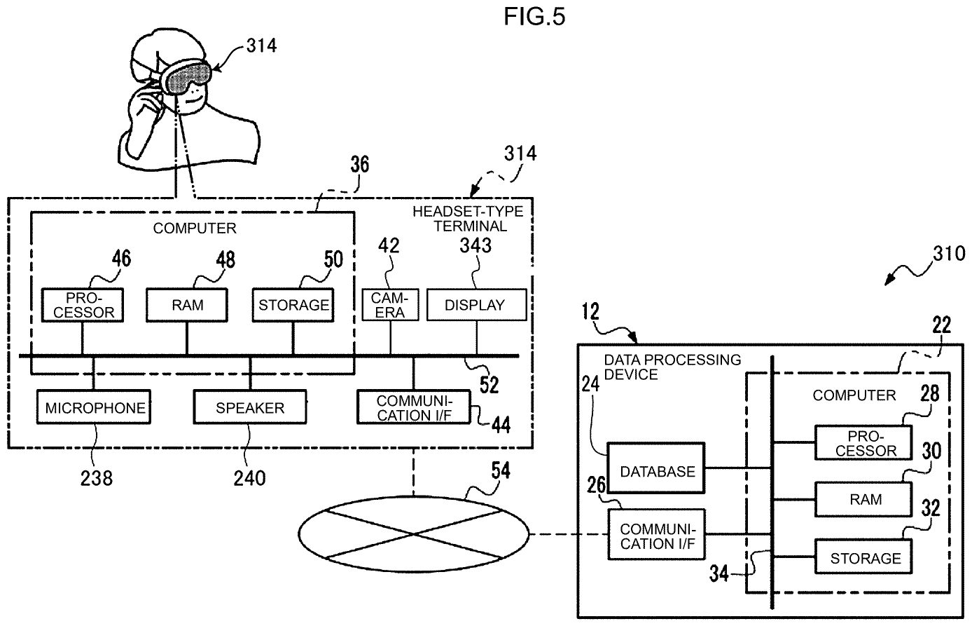

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

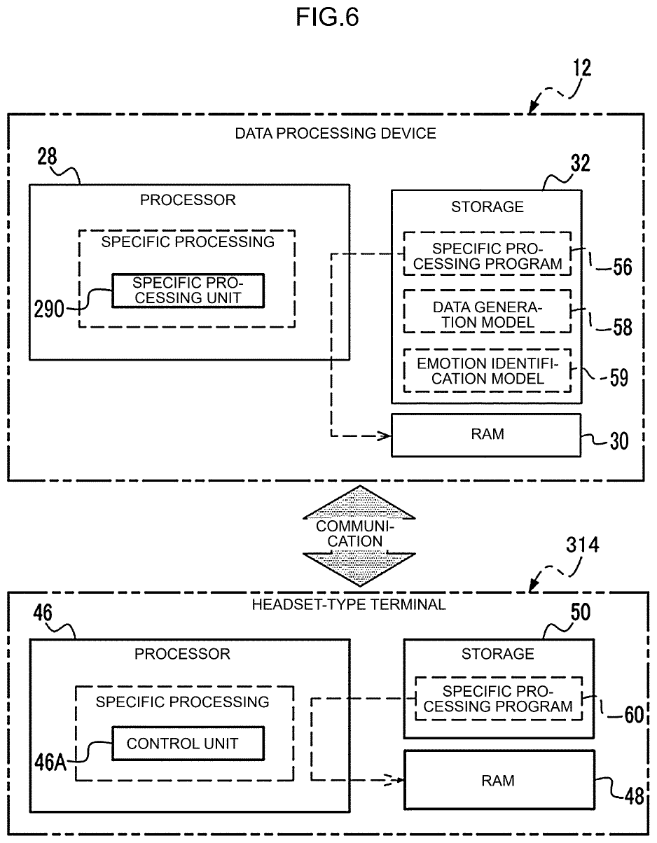

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned issuing unit, confirmation unit, and allocation unit is implemented by at least one of, for example, the headset-type terminal 314 and the data processing apparatus 12. For example, the issuing unit is implemented by a control unit 46A of the headset-type terminal 314 and immediately issues the number of an available parking space upon entry into the parking lot. The confirmation unit can confirm the number using, for example, a display of the headset-type terminal 314 or a smartphone application. The allocation unit is implemented, for example, by a specific processing unit 290 of the data processing apparatus 12 and allocates the number of the parking space according to the vehicle type and the age or skill of the driver. The correspondence between each unit and the apparatus or control unit is not limited to the examples described above and various modifications are possible.

### Fourth Embodiment

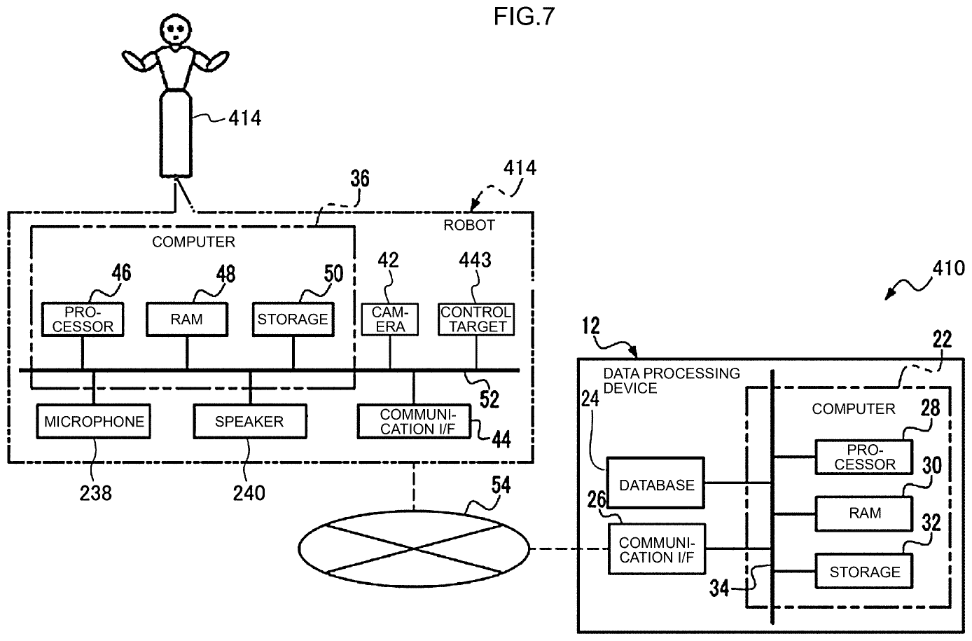

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

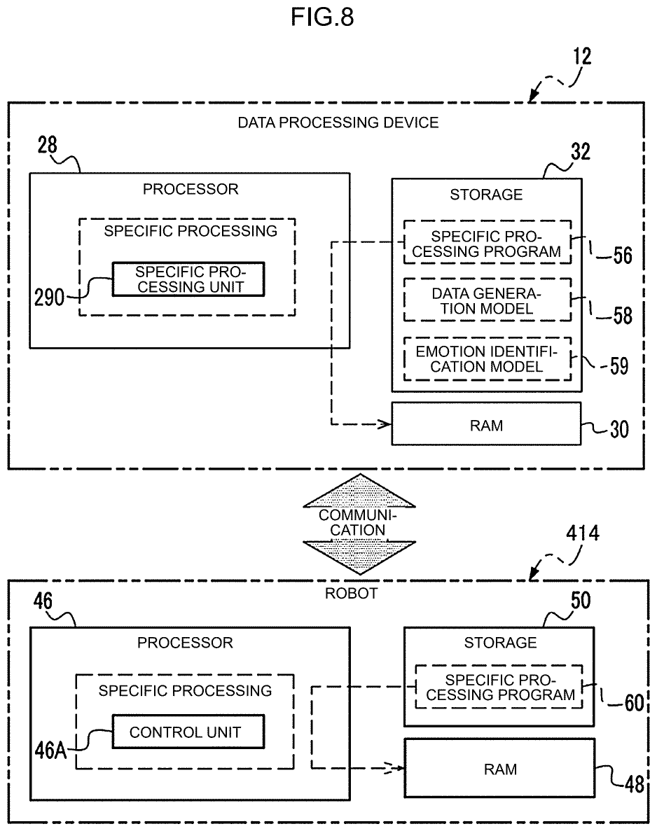

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned issuing unit, confirmation unit, and allocation unit is implemented by at least one of, for example, the robot 414 and the data processing apparatus 12. For example, the issuing unit is implemented by a control unit 46A of the robot 414 and immediately issues the number of an available parking space upon entry into the parking lot. The confirmation unit can confirm the number using, for example, a display of the robot 414 or a smartphone application. The allocation unit is implemented, for example, by a specific processing unit 290 of the data processing apparatus 12 and allocates the number of the parking space according to the vehicle type and the age or skill of the driver. The correspondence between each unit and the apparatus or control unit is not limited to the examples described above and various modifications are possible.

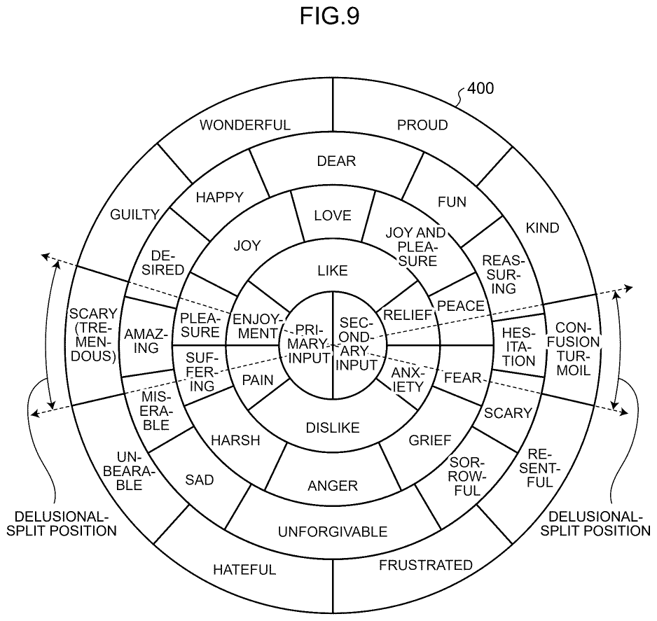

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

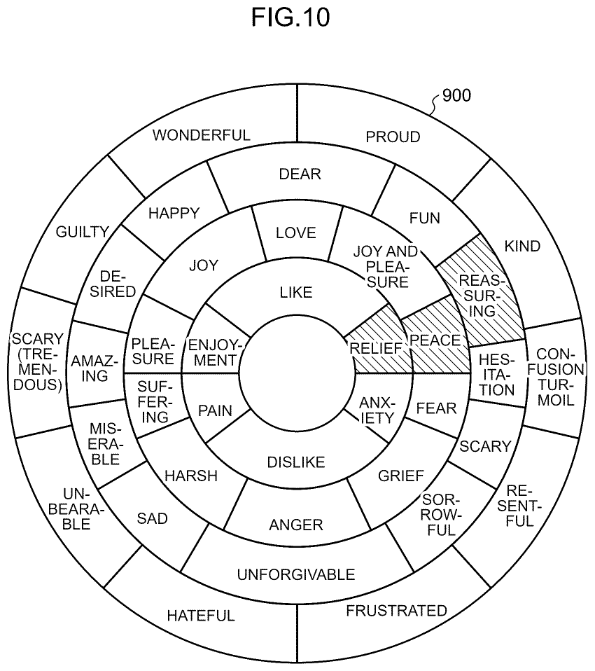

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: an issuing unit configured to immediately issue a number of an available parking space within a parking lot; a confirmation unit configured to confirm the number issued by the issuing unit; and an allocation unit configured to allocate the number of the parking space according to the vehicle type and the age or skill of the driver.
(Supplementary Note 2) The system according to Supplementary Note 1, wherein the confirmation unit is configured to confirm the number via a ticket, a smartphone application, or a monitor of the vehicle.
(Supplementary Note 3) The system according to Supplementary Note 1, wherein the allocation unit is configured to assign a wide parking space or a location with easy access to large vehicles or drivers who are inexperienced in driving.
(Supplementary Note 4) The system according to Supplementary Note 1, wherein the issuing unit is configured to immediately issue the number of an available parking space upon entry into the parking lot.
(Supplementary Note 5) The system according to Supplementary Note 1, wherein the issuing unit is configured to estimate the emotion of the driver and adjust the number of the parking space to be issued based on the estimated emotion of the driver.
(Supplementary Note 6) The system according to Supplementary Note 1, wherein the issuing unit is configured to analyze the congestion status of the parking lot in real time and issue an appropriate parking space number.
(Supplementary Note 7) The system according to Supplementary Note 1, wherein the issuing unit is configured to refer to the usage history of the parking lot and issue the number of a parking space based on past usage patterns.
(Supplementary Note 8) The system according to Supplementary Note 1, wherein the issuing unit is configured to estimate the emotion of the driver and determine the priority of the parking space to be issued based on the estimated emotion of the driver.
(Supplementary Note 9) The system according to Supplementary Note 1, wherein the issuing unit is configured to issue, based on weather information of the parking lot, a covered parking space with priority during rainy weather.
(Supplementary Note 10) The system according to Supplementary Note 1, wherein the issuing unit is configured to issue, based on attribute information of users of the parking lot, a parking space close to facilities for children for families.
(Supplementary Note 11) The system according to Supplementary Note 1, wherein the confirmation unit is configured to estimate the emotion of the driver and adjust the method of displaying the number based on the estimated emotion of the driver.
(Supplementary Note 12) The system according to Supplementary Note 1, wherein the confirmation unit is configured to add a function to display the shortest route to the parking space when confirming the number.
(Supplementary Note 13) The system according to Supplementary Note 1, wherein the confirmation unit is configured to add a function to update the vacancy status of the parking space in real time when confirming the number.
(Supplementary Note 14) The system according to Supplementary Note 1, wherein the confirmation unit is configured to estimate the emotion of the driver and adjust the order of displaying the numbers based on the estimated emotion of the driver.
(Supplementary Note 15) The system according to Supplementary Note 1, wherein the confirmation unit is configured to add a function to display the congestion status within the parking lot when confirming the number.
(Supplementary Note 16) The system according to Supplementary Note 1, wherein the confirmation unit is configured to add a function to display information about facilities surrounding the parking space when confirming the number.
(Supplementary Note 17) The system according to Supplementary Note 1, wherein the allocation unit is configured to estimate the emotion of the driver and adjust the allocation criteria for parking spaces based on the estimated emotion of the driver.
(Supplementary Note 18) The system according to Supplementary Note 1, wherein the allocation unit is configured to refer to the usage history of the parking lot and allocate the optimal parking space when allocating.
(Supplementary Note 19) The system according to Supplementary Note 1, wherein the allocation unit is configured to analyze the congestion status of the parking lot in real time and allocate the optimal parking space when allocating.
(Supplementary Note 20) The system according to Supplementary Note 1, wherein the allocation unit is configured to estimate the emotion of the driver and adjust the order of allocation of parking spaces based on the estimated emotion of the driver.
(Supplementary Note 21) The system according to Supplementary Note 1, wherein the allocation unit is configured to allocate, based on weather information of the parking lot, a covered parking space with priority during rainy weather when allocating.
(Supplementary Note 22) The system according to Supplementary Note 1, wherein the allocation unit is configured to allocate, based on attribute information of users of the parking lot, a parking space close to facilities for children for families when allocating.

What is claimed is:

1. A system comprising:
circuitry configured to:
receive, via a communication interface coupled to a packet-switched network, sensor data packets from a sensor network, the sensor data packets comprising occupancy status flags;
store the sensor data packets in a database as a status tensor comprising feature values indexed by spatial identifiers;
receive, via the communication interface, a query message from a client terminal, the query message comprising user attribute data;
compute, by inputting the status tensor and the user attribute data into a machine learning model comprising at least one of a decision tree, a random forest, or a neural network, a score vector comprising a recommendation score for each spatial identifier;
identify a spatial identifier having a highest recommendation score in the score vector; and
transmit, via the communication interface and the packet-switched network, a response message to the client terminal, the response message comprising the identified spatial identifier.

2. The system according to claim 1, wherein the spatial identifiers comprise parking space numbers within a parking lot, and wherein the sensor network comprises at least one of ultrasonic sensors, magnetic sensors, or image recognition cameras installed in the parking lot.

3. The system according to claim 1, wherein the user attribute data comprises at least one of a vehicle type, an age of a user, a driving history of the user, or a past usage history of the user.

4. The system according to claim 1, wherein the circuitry is further configured to estimate an emotion of a user by applying an emotion identification model to at least one of voice data, a face image, or text input received from the client terminal, and to adjust a weighting parameter of the machine learning model based on the estimated emotion.

5. The system according to claim 4, wherein the circuitry is configured to, when the estimated emotion indicates stress, increase a weighting for spatial identifiers associated with a proximity to an entrance, and when the estimated emotion indicates relaxation, increase a weighting for spatial identifiers associated with a low congestion area.

6. The system according to claim 1, wherein the circuitry is further configured to calculate a congestion score based on a vacancy rate computed from the occupancy status flags, and to adjust an order of spatial identifiers in the score vector based on the congestion score.

7. The system according to claim 1, wherein the circuitry is further configured to retrieve, from the database, a usage history associated with a user identifier in the query message, and to compute the recommendation score based on the usage history.

8. The system according to claim 1, wherein the circuitry is further configured to receive weather data from an external weather source via the communication interface, and to adjust the recommendation score for each spatial identifier based on the weather data.

9. The system according to claim 8, wherein the circuitry is configured to, when the weather data indicates rain, increase the recommendation score for spatial identifiers associated with a covered area.

10. The system according to claim 1, wherein the circuitry is further configured to adjust the recommendation score for each spatial identifier based on attribute information of the user, such that for users associated with a family attribute, the recommendation score for spatial identifiers near a facility for children is increased.

11. The system according to claim 1, wherein the circuitry is further configured to generate route data comprising a shortest path from a current location of the client terminal to a location associated with the identified spatial identifier, and to include the route data in the response message.

12. The system according to claim 1, wherein the circuitry is further configured to estimate an emotion of a user by applying an emotion identification model to sensor data received from the client terminal, and to adjust a display format parameter in the response message based on the estimated emotion.

13. The system according to claim 12, wherein the circuitry is configured to, when the estimated emotion indicates stress, set the display format parameter to a simplified display mode, and when the estimated emotion indicates relaxation, set the display format parameter to a detailed display mode.

14. The system according to claim 1, wherein the circuitry is further configured to update the status tensor in real time based on newly received sensor data packets, and to transmit an updated response message to the client terminal when the occupancy status flag associated with the identified spatial identifier changes.

15. The system according to claim 1, wherein the circuitry is further configured to store, in the database, safety information associated with each spatial identifier, the safety information comprising at least one of a location of a security camera, a location of an emergency exit, or a lighting intensity, and to include the safety information in the response message.

16. The system according to claim 1, wherein the circuitry is further configured to receive, from the client terminal via the communication interface, a reservation request message comprising a desired time period, and to update the status tensor to indicate a reserved status for the identified spatial identifier during the desired time period.

17. The system according to claim 1, wherein the circuitry is further configured to retrieve, from the database, a membership status associated with a user identifier in the query message, and to increase the recommendation score for spatial identifiers associated with a preferred location when the membership status indicates a premium membership.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a machine learning model comprising at least one of a decision tree, a random forest, or a neural network, and an emotion identification model;
a database; and
circuitry configured to:
receive, via the communication interface, sensor data packets from a sensor network, the sensor data packets comprising occupancy status flags for a plurality of spatial units;
store the sensor data packets in the database as a status tensor comprising feature values indexed by spatial identifiers;
receive, via the communication interface, a query message from the client terminal, the query message comprising user attribute data;
estimate an emotion of a user by applying the emotion identification model to at least one of voice data captured by the microphone or image data captured by the camera of the client terminal;
compute, by inputting the status tensor, the user attribute data, and the estimated emotion into the machine learning model, a score vector comprising a recommendation score for each spatial identifier;
identify a spatial identifier having a highest recommendation score in the score vector; and
transmit, via the communication interface and the packet-switched network, a response message to the client terminal, the response message comprising the identified spatial identifier and causing the client terminal to present the identified spatial identifier to the user via at least one of the display or the speaker.

19. The system according to claim 18, wherein the machine learning model is obtained by deep learning on a neural network, and wherein the machine learning model is a fine-tuned model configured to output inference results from input data without additional instructions.

20. A method performed by circuitry of a system comprising a communication interface coupled to a packet-switched network, a memory storing a machine learning model comprising at least one of a decision tree, a random forest, or a neural network, and a database, the method comprising:
receiving, via the communication interface, sensor data packets from a sensor network, the sensor data packets comprising occupancy status flags;
storing the sensor data packets in the database as a status tensor comprising feature values indexed by spatial identifiers;
receiving, via the communication interface, a query message from a client terminal, the query message comprising user attribute data;
computing, by inputting the status tensor and the user attribute data into the machine learning model, a score vector comprising a recommendation score for each spatial identifier;
identifying a spatial identifier having a highest recommendation score in the score vector; and
transmitting, via the communication interface and the packet-switched network, a response message to the client terminal, the response message comprising the identified spatial identifier.
